(19) United States
(12) Patent Application Publication
(10) Pub. No.: US 2015/0054796 A1
(43) Pub. Date: Feb. 26, 2015

(54) LIGHT-ENERGY STYLUS AND A METHOD OF OPERATING THE SAME

(71) Applicant: HengHao Technology Co. LTD, Taoyuan County (TW)

(72) Inventor: MING-SHAN KUO, Taoyuan County (TW)

(73) Assignee: HengHao Technology Co. LTD, Taoyuan County (TW)

(21) Appl. No.: 14/024,854

(22) Filed: Sep. 12, 2013

(30) Foreign Application Priority Data
Aug. 23, 2013 (TW) 102130144

(51) Int. Cl. G06F 3/0354

(52) U.S. Cl. CPC G06F 3/03545
USPC 345/179

(57) ABSTRACT

A light-energy stylus with a light guide having a distal end disposed near a tip of a housing and exposed on a surface of the housing. Light enters the light guide from the distal end, travels through the light guide and is then collected at a proximal end of the light guide. A photovoltaic element converts the collected light into electrical energy. Accordingly, in addition to performing touch functions, the light-energy stylus may execute bi-directional data communication with a touch panel.

### BACKGROUND OF THE INVENTION

1. Field of the Invention

The disclosure generally relates to a stylus, and more particularly to a light-energy stylus.

2. Description of Related Art

A touch screen is commonly operated by fingers. However, the touch screen may be operated by a stylus in a more accurate manner, and no oil stain will be left on a touch surface of the touch screen.

One of disadvantages of a conventional stylus, particularly an active stylus, is the requirement of batteries or being pre-charged. The stylus becomes useless after being used for a long duration or being forgotten to charge beforehand. An electromagnetic stylus (usually a passive stylus) is proposed to obtain electrical power from electromagnetic wave received by induction coils. The electromagnetic wave, however, may interfere with nearby electronic devices, and may be harmful to human body.

A need has arisen to propose a novel stylus to overcome problems of the conventional stylus in order to make it more convenient to use.

### SUMMARY OF THE INVENTION

In view of the foregoing, it is an object of the embodiment of the present invention to provide a light-energy stylus that guides light from a display module of a touch screen, and then converts the light into electrical energy for providing power required by circuits disposed in the light-energy stylus.

According to one embodiment, a light-energy stylus includes a housing, a light guide and a photovoltaic element. The light guide is disposed in the housing, a distal end of the light guide being disposed near a tip of the housing and exposed on a surface of the housing, light entering the light guide from the distal end, traveling the light guide and being then collected at a proximal end of the light guide. The photovoltaic element is disposed in the housing, and configured to convert light energy of the collected light into electrical energy.

### BRIEF DESCRIPTION OF THE DRAWINGS

FIG. 1 shows a schematic diagram illustrating a light-energy stylus according to one embodiment of the present invention;

FIG. 2 shows a schematic diagram illustrating a touch screen;

FIG. 3 shows a schematic diagram illustrating a light-energy stylus according to another embodiment of the present invention; and

FIG. 4 shows a block diagram of the drive circuit of FIG. 1.

### DETAILED DESCRIPTION OF THE INVENTION

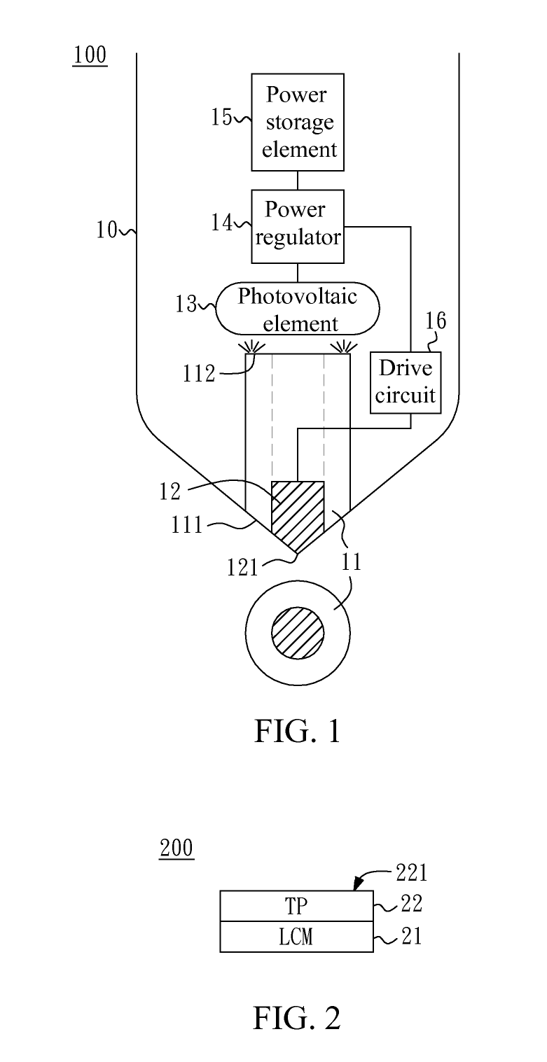

FIG. 1 shows a schematic diagram illustrating a stylus driven by light-energy (or a “light-energy stylus” for short) 100 according to one embodiment of the present invention. The light-energy stylus 100 of the embodiment is an active stylus capable of interacting with a touch screen. FIG. 2 shows a schematic diagram illustrating a touch screen 200, which includes a display module (e.g., a liquid crystal module (LCM)) 21 and a touch panel (TP) 22. Specifically, the touch panel 22 is disposed above the display module 21, and a top surface of the touch panel 22 acts as a touch surface 221. Light generated by the display module 21 may pass through the touch panel 22, and may be emitted from the touch surface 221.

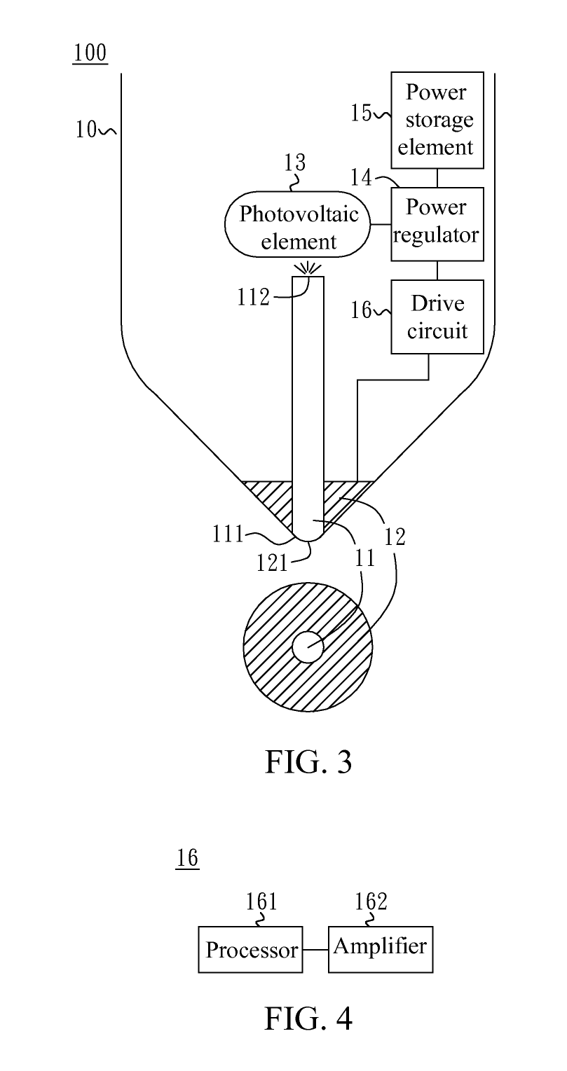

In the embodiment, the light-energy stylus 100 includes at least one light guide 11, such as a light tube or an optical fiber, disposed in a housing 10. A distal end 111 of the light guide 11 is disposed near a tip 121 of the housing 10. A conductive block (e.g., a metal block) 12 may be disposed at the tip 121 of the housing 10. As shown in FIG. 1, the distal end 111 of the light guide 11 may be exposed on a surface of the housing 10, and may surround the conductive block 12. FIG. 3 shows a schematic diagram illustrating a light-energy stylus 100 according to another embodiment of the present invention. As shown in FIG. 3, the distal end 111 of the light guide 10 may be exposed on a surface of the housing 10, and may be coincided with the tip 121 of the housing 10 such that the conductive block 12 surrounds the light guide 11 (alternatively speaking, the distal end 111 of the light guide 11 passes through, for example, a center of the conductive block 12).

When the tip 121 of the housing 10 approaches or touches the touch surface 221 of the touch screen 200, the light emitted from the touch surface 221 may enter the light guide 11 from the distal end 111, travel through the light guide 11 and be collected at a proximal end 112 of the light guide 11.

The light-energy stylus 100 of the embodiment may further include a photovoltaic element 13 disposed in the housing 10. The photovoltaic element 13 converts light energy of the collected light into electrical energy (e.g., electrical current). The photovoltaic element 13 may be a concentrated photovoltaic cell, also named chemical compound-based solar cell, having an active layer made from group III-V compound such as gallium arsenic (GaAs), indium gallium arsenic (InₓGa₁₋ₓAs), aluminum phosphorus (AlP), or gallium phosphorus (GaP). Alternatively, the photovoltaic element 13 may be a silicon-based solar cell, having an active layer made from a silicon wafer or thin film, where the silicon wafer may be monocrystalline silicon, multicrystalline silicon, or ribbon silicon, and the thin film may be cadmium telluride (CdTe), copper indium gallium selenide (CIGS), or amorphous silicon (A-Si). Generally speaking, conversion efficiency of the silicon-based solar cell is lower than the concentrated photovoltaic cell.

The light-energy stylus 100 of the embodiment may further include a power regulator 14 disposed in the housing 10. The power regulator 14 may receive and regulate the electrical energy (e.g., current) converted by the photovoltaic element 13, therefore resulting in stable power. The power regulator 14 may be implemented by a variety of circuits of conventional power regulators, and details of implementation are omitted for brevity.

The embodiment may further include a power storage element 15 disposed in the housing 10. The power storage element 15 may, for example, be a rechargeable battery or a supercapacitor for storing a portion of the electrical energy converted by the photovoltaic element 13.

The stable power outputted from the power regulator 14 is provided as required power to a drive circuit 16 that is disposed in the housing 10. FIG. 4 shows a block diagram of the drive circuit 16. In the embodiment, the drive circuit 16 may include a processor (e.g., a microprocessor) 161, output signals of which are then amplified by an amplifier (e.g., an operational amplifier) 162, therefore resulting in drive signals electrically coupled to the conductive block 12. Accordingly, when the tip 121 of the housing 10 of the light-energy stylus 100 approaches or touches the touch surface 221 of the touch screen 200, the light-energy stylus 100 may interact with the touch screen 200 to perform various functions via drive signals transmitted from the conductive block 12 or via signals received from the touch panel 22. The drive signals may, for example, be touch point signals generated by the tip 121 of the light-energy stylus 100, Z-axis signals resulted from press of the tip 121 of the light-energy stylus 100, signals associated with buttons (not shown) of the housing 10 of the light-energy stylus 100, or signals transmitted to the tip 121 of the light-energy stylus 100 from the touch panel 22. Accordingly, in addition to performing touch functions, the light-energy stylus 100 may execute bi-directional data communication with a touch panel 22.

Although specific embodiments have been illustrated and described, it will be appreciated by those skilled in the art that various modifications may be made without departing from the scope of the present invention, which is intended to be limited solely by the appended claims.

What is claimed is:

1. A light-energy stylus, comprising:
a housing;
a light guide disposed in the housing, a distal end of the light guide being disposed near a tip of the housing and exposed on a surface of the housing, light entering the light guide from the distal end, traveling the light guide and being then collected at a proximal end of the light guide; and
a photovoltaic element disposed in the housing, the photovoltaic element being configured to convert light energy of the collected light into electrical energy.

2. The light-energy stylus of claim 1, further comprising a conductive block disposed at the tip of the housing.

3. The light-energy stylus of claim 2, wherein the distal end of the light guide surrounds the conductive block.

4. The light-energy stylus of claim 2, wherein the distal end of the light guide passes through the conductive block.

5. The light-energy stylus of claim 1, wherein the photovoltaic element comprises a concentrated photovoltaic cell.

6. The light-energy stylus of claim 1, wherein the photovoltaic element comprises a silicon-based solar cell.

7. The light-energy stylus of claim 1, further comprising a power regulator disposed in the housing, the power regulator receives and regulates the electrical energy converted by the photovoltaic element, thereby resulting in stable power.

8. The light-energy stylus of claim 1, further comprising a power storage element disposed in the housing, the power storage element storing a portion of the electrical energy converted by the photovoltaic element.

9. The light-energy stylus of claim 7, further comprising a drive circuit disposed in the housing, the drive circuit receiving the stable power from the power regulator.

10. The light-energy stylus of claim 9, wherein the drive circuit comprises:
a processor; and
an amplifier configured to amplify output signals of the processor, thereby resulting in drive signals to be transmitted from the tip of the housing, or to receive signals from a touch panel.

11. A method of operating a light-energy stylus, comprising:
providing a housing and a light guide disposed therein;
light entering the light guide from a distal end of the light guide, traveling the light guide and being then collected at a proximal end of the light guide; and
converting light energy of the collected light into electrical energy.

12. The method of claim 11, further comprising:
receiving and regulating the converted electrical energy, thereby resulting in stable power.

13. The method of claim 11, further comprising:
storing a portion of the converted electrical energy.

14. The method of claim 12, further comprising:
receiving the stable power; and
amplifying signals to result in drive signals to be transmitted from a tip of the housing, or receiving signals from a touch panel.
